(19) United States
(12) Patent Application Publication
(10) Pub. No.: US 2007/0064948 A1
(43) Pub. Date: Mar. 22, 2007

(54) Methods and apparatus for the utilization of mobile nodes for state transfer

(76) Inventors: George Tsirtsis, New York, NY (US); M. Scott Corson, Gillette, NJ (US); Vincent Park, Budd Lake, NJ (US)

Correspondence Address: STRAUB & POKOTYLO, 620 TINTON AVENUE, BLDG. B, 2ND FLOOR, TINTON FALLS, NJ, 07724, US

(21) Appl. No.: 11/288,597

(22) Filed: Nov. 29, 2005

Related U.S. Application Data
(60) Provisional application No. 60/718,363, filed on Sep. 19, 2005.

(51) Int. Cl. H04K 1/00

(52) U.S. Cl. 380/270

(57) ABSTRACT

Methods and apparatus for storing, manipulating, retrieving, and forwarding state, e.g., context and other information, used to support communications sessions with one or more end nodes, e.g., mobile devices, are described. Various features are directed to a end node controlling the transfer of state from a first access node to a second access node during a handoff operation thereby eliminating any need for state transfer messages to be transmitted between the second access node and the first access node during handoff or the use of a core network node to support state transfer. As part of a handoff state information is obtained by an end node from the current access node in encrypted form and then communicated to the new access node to which the handoff operation is to be completed. The new access node, e.g., base station decrypts the state information and then uses it to support communications with the end node. While the information is communicated to and from the end node over wireless links, since it is encrypted by the first access node it is secure and can be trusted by the receiving, e.g., target, access node.

### RELATED APPLICATION

The present invention claims the benefit of U.S. Provisional Patent Application Ser. No. 60/718,363, filed Sep. 19, 2005 which is hereby expressly incorporated by reference.

### BACKGROUND OF INVENTION

Communications system frequently include a plurality of network nodes which are coupled to access nodes through which end nodes, e.g., mobile devices, are coupled to the network. Network nodes may be arranged in a hierarchy. Access Authentication and Authorization (AAA) servers are nodes which are normally placed relatively high in the network hierarchy. They normally provide information used for security and access control purposes. Access nodes frequently have a secure link with an AAA server in cases where such servers are used. The secure link may be through one or more node in the hierarchy.

Operators typically manage access sessions in IP networks using the RADIUS protocol and associated RADIUS AAA servers. In the future, AAA systems may be based on new protocols such as DIAMETER. In a system using a RADIUS AAA server, when a user attempts to gain access to an operator network, for the duration of an access session, the local Access Router normally issues one or more RADIUS Access-Requests to an Authentication Server to authenticate that user based on its identity such as a Network Access Identifier (NAI). The AAA database typically has stored the identities of those users allowed to access its system along with the services features they are able to invoke. When the user is successfully authenticated, its access port on the access device is configured with policy state commensurate with the user's service Authorization. The service authorization is normally delivered via RADIUS to the Access Router by the Authorization Server. Whilst authorized, service usage during an access session is recorded by the Access Router, and sent as accounting records to an Accounting Server using Accounting-Request messages in the RADIUS protocol. The Accounting Server may be part of the AAA server or it may be an independent server using the same protocol with the authorization server. If the user is connected to multiple Access Routers during a single session then the multiple sessions need to be aggregated in the Accounting Servers.

In addition to authorization and accounting issues, communications systems which support mobile devices need to include mechanisms for conveying location information so that a mobile device can change its point of attachment to the network and still have signals, e.g., IP packets, routed to it.

Mobile IP, (versions 4 and 6) also known as MIPv4 [MIPv4] and MIPv6 [MIPv6], enables a mobile node (MN) to register its temporary location indicated by a care-of-address (CoA) to its Home Agent (HA). The HA then keeps a mapping (also called a binding) between the MN's permanent address, otherwise called Home Address (HoA), and the registered CoA so that packets for that MN can be redirected to its current location using IP encapsulation techniques (tunneling). The CoA used by a MN can be an address that belongs to a Foreign Agent (FA) in an Access Router when MIPv4 is used or it can be a temporarily allocated address to the MN itself, from the Access Router prefix, in which case it is called a collocated care-of-address (CCoA). The latter model also applies to MIPv4 while it is the only mode of operation in MIPv6. Note that for the purpose of this document the terms CCoA and CoA as well as Registration and Binding Update (BU) are interchangeable since they are the corresponding terms for MIPv4 and MIPv6. The methods and apparatus of the invention are applicable to both MIPv4 and MIPv6 unless otherwise mentioned.

AAA systems are typically used with mobile IP to manage IP address allocations (HoAs), to dynamically allocate HAs, to distribute MN profiles to the Access Router and also to distribute security keys to authenticate MIP messages and to secure the air-link. The Mobile Node, an end node which is capable of changing its point of network attachment, typically sends a MIP message to gain access to the system, which triggers an AAA request to authenticate and authorize the Mobile Node. The AAA MN profile and security state is then passed from the AAA system to the Access Router to control services consumed by the MN.

MNs may change their point of network attachment, e.g., as they move from one cell to another cell. This involves changing the MNs point of attachment from a first access node, e.g., a first router, to a second access node, e.g., a second router. This processes is commonly known as a handoff. As part of a handoff the MN's CoA/CCoA needs to be updated and then transferred into the HA using MIP signaling so that packets are redirected to the MN via the new Access Router. As part of handoff process, it is necessary to transfer at least some of the first access router's state information corresponding to the MN involved in the handoff to the new access router so that the MN service is not interrupted. This process is known as State Transfer. State transfer may include, e.g., the transfer of AAA profile state information that was previously delivered via RADIUS to the AR, at which the MN access session commenced. It also may include, e.g., the transfer of air-link security vectors, MN-NAI, MN IP Address, MN-EUI-64, remaining MIP Registration Lifetime, MN multicast group membership, admission control state, resource reservation state, diff-serv state, SIP session state, compressor state, MN scheduling history and/or many other potential items of MN specific AR state information.

In at least one known system, the transfer of state information during a handoff is accomplished by the new access node to which a mobile node is connecting sending a state transfer message through the communications network to the old access node to which the mobile node was connected. In response the old access node forwards state information to the new access node. This technique, while effective, has the disadvantage of requiring that a message be sent between the old and new access nodes to initiate the transfer of the state information. The links between access nodes used for the transmission of such messages may become congested or could be used to convey other information and/or signals if the need for messages between access nodes used to initiate the transfer of state information could be eliminated.

In view of the above discussion, it should be appreciated that there is a need for new methods of implementing the communication of state information to a new access node in the case of a mobile node handoff or in other cases where a mobile node enters a new cell. It should also be appreciated that, for the reasons discussed above, avoiding the use of messages between access nodes to trigger the transfer of state information during a handoff is desirable.

### SUMMARY OF THE INVENTION

In a wireless network, mobile end users use end nodes, e.g., wireless devices, to communicate with other network entities, e.g., wireless devices used by other end users, via access nodes. The access nodes may be implemented as wireless access routers. The access nodes may be, e.g., base stations. Associated with each end node there is state, e.g., a set of information comprising various parameters relating to service(s) and/or application(s) corresponding to the end node. This state is used by an access router which serves as the end node's point of network attachment. Each time the end node changes the point of attachment to the network, the state should be re-built or transferred to the access router which serves as the new point of network attachment so that the new access node can continue to provide communication services with regard to existing communications sessions or provide new communications services, e.g., as requested by the end node. The methods and apparatus of the present invention are directed to a novel method of transferring state between access points/routers through the use of a wireless terminal, e.g., mobile node, as the conduit for the state information.

The transferred state may, and in some embodiments does, include one or more of the following: an access key to be used in obtaining at least one of secure access and authenticated access to said second access node; a master session key to be used in obtaining at least one of secure access and authenticated access to said second access node; service authorization information indicating at least one service the end node is authorized to be provided with; a communications session identifier identifying an ongoing communications session, resource allocation information indicating resources allocated to an ongoing communications session; air link resource information; communications group membership information; an IP address assigned to said end node and an address lifetime corresponding to said IP address.

In accordance with the invention, the wireless terminal is provided with a large amount of control over the handoff process and the need to transfer state through one or more core network elements or from one base station to another via a backhaul link can be avoided. This is because the mobile node receives the relevant state information from the current base station as part of a handoff and then communicates the state to a new base station as part of a handoff procedure. The communication of the state information to the mobile node and the transfer of the state information to the new base station, e.g., the target base station, can be provided over wireless connections. After the transfer a communications session which was ongoing with another node, e.g., another end node, may be continued through the target base station through the use at the target base station of transferred state.

For security reasons, the state information is encrypted in some embodiments by the first base station prior to transmission. The base stations in the system maintain a security association, e.g., by having common access to a security server in the network. Thus, in various embodiments, the target base station is able to decode the encrypted state information, using a shared secret accessible to the current base station and the target base station, while the mobile node can not. Also, while the state information is communicated from the old base station to the mobile over an airlink and then from the mobile node to the new base station over an air link, security is maintain due to the encrypted nature of the transmitted information.

After successful decryption of the state information, the target base station is able to serve as the mobile nodes new point of network attachment. The target base station may send one or more routing messages to various nodes in the network after successful decryption of the state information received from the mobile node. Such messages may be used to update network routing information so that IP packets intended for the mobile node will be directed to the target base station instead of the old base station.

The state transfer methods and apparatus of the present invention can be used in both make before break handoffs and break before make handoffs. In the case of break before make handoffs the connection with the old base station is terminated following transfer of the signed and optionally encrypted state to the mobile node and before the connection with the target base station is established. Thus, in such embodiments, the connection with the old base station may be terminated prior to the target base station receiving the state information.

In accordance with the invention, the old base station need not be informed of the target base station. If a handoff to a first target base station fails, e.g., due to communications problems or lack of communications capacity, the mobile node can complete the handoff to a second target base station. In such a case, the state information stored in the mobile node would be transmitted from the mobile node to the second target base station, e.g., instead of the first target base station. Thus, it should be appreciated that the mobile nodded based state transfer methods of the present invention provide a highly flexible system where the mobile node is allowed a great deal of flexibility and control over handoffs. In particular, depending on the implementation, the mobile node can control one or more of the following: 1) determining when to perform a handoff, 2) selecting one or more target base stations to which a handoff is completed; and 3) changing the target of a handoff operation should a handoff to an initial target base station fail or conditions change. Such decisions and operations can be performed in accordance with the invention without having to first notify a master network controller in the communications network or receiving authorization for a handoff from a master network controller located in the core of the network.

The nature of the state transported, according to this invention, may be purely under the control of the base station that controls the state. However, the mobile node may request the transfer of particular state. In some but not necessarily all embodiments of the invention, one base station serves as a primary base station for a given terminal at nay point in time, although it is possible that a terminal is connected to multiple base stations at the same time. In such embodiments, the primary base station is the one that controls and is responsible for maintaining the currency of the state required to support the terminal's communications, e.g., voice or data communications sessions. The primary base station, in one such embodiment may send state to the terminal as the state for the terminal is updated. The state can be stored in the mobile and can be transferred to another access node when needed, e.g., upon handoff. State stored in the access node may be replaced or updated using additional state received from the first access node. Thus, changed or updated state sent to the end node after some first state received from an access node has already been stored in the end node, may be used to replace or update the older stored state. As a result of updating of the stored state, current state will be provided to an access node as part of a handoff or other state update operation. It should be appreciated that the state transfer methods of the invention can be used for synchronizing state used by multiple access nodes and not simply as part of a handoff procedure.

In an alternative embodiment of the invention the primary base station sends the state to the terminal on terminal's request, e.g., at the time the terminal wants to handoff, it requests said state from its primary base station.

By distributing handoff control and state transfer functionality in such a way that a handoff can occur without the need to transmit state information through the core of the network, a great deal of resiliency can be achieved. Furthermore, in some embodiments, updates and modifications to handoff procedures can be implemented overtime without having to make changes to network elements in the core of a communications network. This is particularly desirable in systems where base stations and mobile nodes are controlled by a service provider and another entity is responsible for core network functions, e.g., the backhaul between routers or base stations.

In view of the above discussion, it should be appreciated that the present application describes methods for transfer of state to support events such as the movement of an end node (EN) between access nodes (ANs). The methods use the end nodes, e.g., mobile nodes, to store and/or forward state information between access nodes as part of a handoff or another process. In addition to the case of handoffs, the methods and apparatus can be used for updating and maintaining state in multiple access nodes, e.g., when an end node maintains connections with multiple access nodes at the same time. The methods of the invention can be used in other state update applications as well.

Additional features and benefits of the present invention are discussed in the detailed description which follows.

### BRIEF DESCRIPTION OF THE DRAWINGS

FIG. 1 illustrates a network diagram of an exemplary communications system in which the invention is applicable.

FIG. 2 illustrates an exemplary end node implemented in accordance with the present invention.

FIG. 3 illustrates an exemplary access node implemented in accordance with the present invention.

FIG. 4 illustrates signaling performed in accordance with the present invention when an end node performs a handoff from one access node to another access node.

FIG. 5 illustrates signaling in accordance with another handoff embodiment of the present invention.

### DETAILED DESCRIPTION

The methods and apparatus of the present invention for storing, manipulating, retrieving, and forwarding state, e.g., context and other information used to support communications sessions with one or more end nodes, e.g., mobile devices, can be used with a wide range of communications systems. For example the invention can be used with systems which support mobile communications devices such as notebook computers equipped with modems, PDAs, and a wide variety of other devices which support wireless interfaces in the interests of device mobility. The methods and apparatus are well suited for use in wireless communications systems, e.g., systems which use OFDM signals or other types of signals transmitted over wireless communications channels.

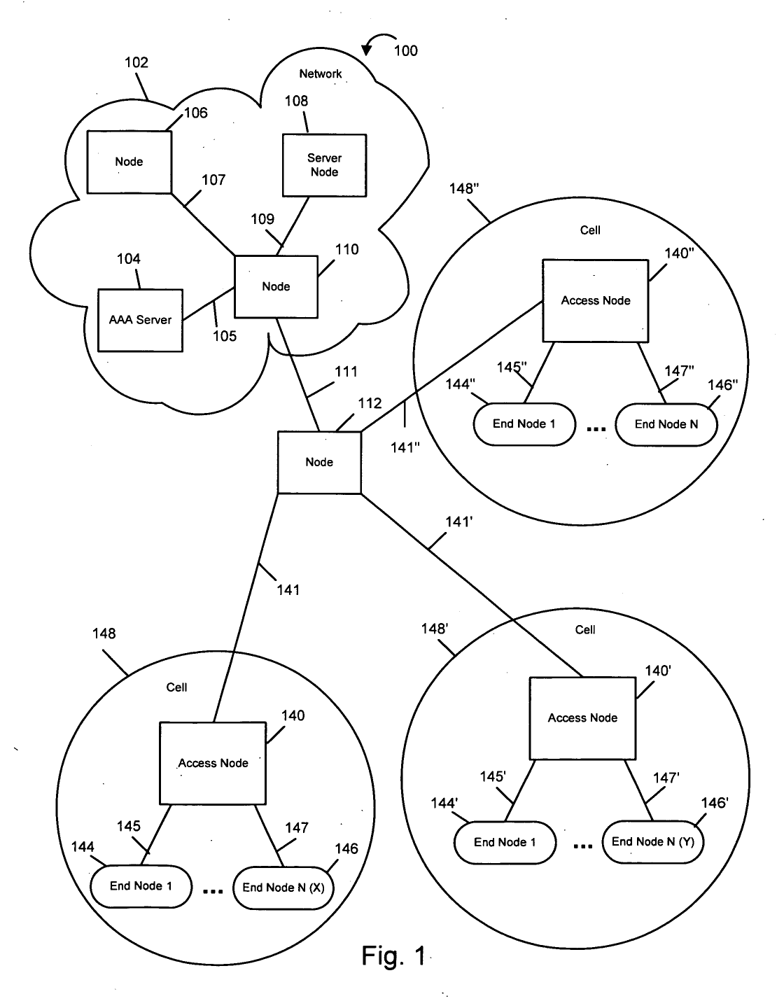

FIG. 1 illustrates an exemplary communication system 100, e.g., a cellular communication network, which comprises a plurality of nodes interconnected by communications links. Nodes in the exemplary communication system 100 exchange information using signals, e.g., messages, based on communication protocols, e.g., the Internet Protocol (IP). The communications links of the system 100 may be implemented, for example, using wires, fiber optic cables, and/or wireless communications techniques. The exemplary communication system 100 includes a plurality of end nodes 144, 146, 144′, 146′, 144″, 146″, which access the communication system via a plurality of access nodes 140, 140′, 140″. The end nodes 144, 146, 144′, 146′, 144″, 146″ may be, e.g., wireless communication devices or terminals, and the access nodes 140, 140′, 140″ may be, e.g., wireless access routers or base stations. The exemplary communication system 100 also includes a number of other nodes 104, 106, 108, 110, and 112, used to provide interconnectivity or to provide specific services or functions. Specifically, the exemplary communication system 100 includes a AAA server 104 used to provide security and accounting services. The AAA server 104 is optional but, in some embodiments is used to provide access nodes with secure keys, e.g., “shared secrets” which can be used to signed and encrypt state information being communicated from one access node as needed, e.g., base station, to another using an end node, e.g., mobile node, as a conduit for the state information relating to the mobile node used to convey the information. Node 106 of FIG. 1 is optional, but in embodiments in which the node 106 is present, the node 106 can serve as a node with which end nodes 144, 146, 144′, 146′, 144″, 146″ can communicate. Server Node 108 of FIG. 1 is also optional. In embodiments where the server node 108 is used, the server node 108 can serve as an application server offering application services to end nodes 144, 146, 144′, 146′, 144″, 146″.

The FIG. 1 exemplary system 100 depicts a network 102 that includes the AAA server 104 and the node 106, both of which are connected to an intermediate network node 110 by a corresponding network link 105 and 107, respectively. The intermediate network node 110 in the network 102 also provides interconnectivity to network nodes that are external from the perspective of the network 102 via network link 111. Network link 111 is connected to another intermediate network node 112, which provides further connectivity to a plurality of access nodes 140, 140′, 140″ via network links 141, 141′, 141″, respectively.

Each access node 140, 140′, 140″ is depicted as providing connectivity to a plurality of N end nodes (144, 146), (144′, 146′), (144″, 146″), respectively, via corresponding access links (145, 147), (145′, 147′), (145″, 147″), respectively. In the exemplary communication system 100, each access node 140, 140′, 140″ is depicted as using wireless technology, e.g., wireless access links, to provide access. A radio coverage area, e.g., communications cell, 148, 148′, 148″ of each access node 140, 140′, 140″, respectively, is illustrated as a circle surrounding the corresponding access node.

The exemplary communication system 100 which implements the invention, is subsequently used as a basis for the description of various embodiments of the invention. Alternative embodiments of the invention include various network topologies, where the number and type of network nodes, the number and type of access nodes, the number and type of end nodes, the number and type of links, and the interconnectivity between nodes may differ from that of the exemplary communication system 100 depicted in FIG. 1.

In various embodiments of the present invention some of the functional entities depicted in FIG. 1 may be omitted or combined. The location or placement of these functional entities in the network may also be varied. For example, in some embodiments, the AAA server 104 is not used. In such embodiments which do not use a AAA server, the base stations may be programmed by a system administrator with a shared secret. Such embodiments are particularly well suited for networks managed by one or a few individuals, e.g., corporate or home networks where individual network access points may be deployed and configured, e.g., one or a few at a time.

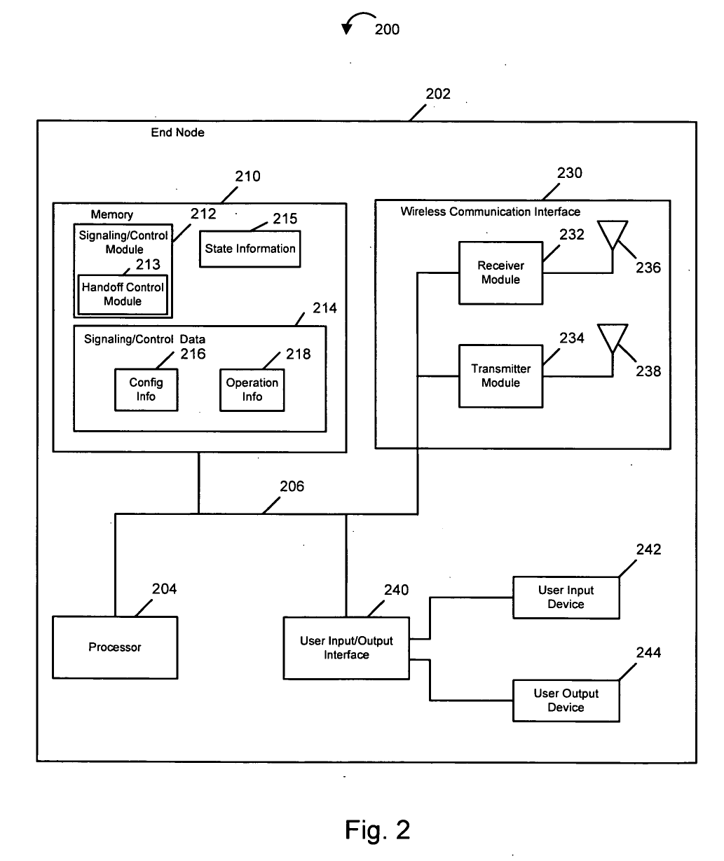

FIG. 2 provides a detailed illustration of an exemplary end node 200 implemented in accordance with the present invention. The exemplary end node 200, depicted in FIG. 2, is a detailed representation of an apparatus that may be used as any one of the end nodes 144, 146, 144′, 146′, 144″, 146″, depicted in FIG. 1. In the FIG. 2 embodiment, the end node 200 includes a processor 204, a wireless communication interface 230, a user input/output interface 240 and memory 210 coupled together by bus 206. Accordingly, via bus 206 the various components of the end node 200 are coupled together and can exchange information, signals and data. The components 204, 206, 210, 230, 240 of the end node 200 are located inside a housing 202.

The wireless communication interface 230 provides a mechanism by which the internal components of the end node 200 can send and receive signals to/from external devices and network nodes, e.g., access nodes. The wireless communication interface 230 includes, e.g., a receiver module 232 with a corresponding receiving antenna 236 and a transmitter module 234 with a corresponding transmitting antenna 238 used for coupling the end node 200 to other network nodes, e.g., via wireless communications channels. The receiver and transmitter modules 232, 234 can receive and transmit OFDM signals in various embodiments of the invention and can operate under control of the handoff control module 213 to transmit and receive various handoff related signals.

The exemplary end node 200 also includes a user input device 242, e.g., keypad, and a user output device 244, e.g., display, which are coupled to bus 206 via the user input/output interface 240. Thus, user input/output devices 242, 244 can exchange information, signals and data with other components of the end node 200 via user input/output interface 240 and bus 206. The user input/output interface 240 and associated devices 242, 244 provide a mechanism by which a user can operate the end node 200 to accomplish various tasks. In particular, the user input device 242 and user output device 244 provide the functionality that allows a user to control the end node 200 and applications, e.g., modules, programs, routines and/or functions, that execute in the memory 210 of the end node 200.

The processor 204 under control of various modules, e.g., routines, included in memory 210 controls operation of the end node 200 to perform various signaling and processing as discussed below. The modules included in memory 210 are executed on startup or as called by other modules. Modules may exchange data, information, and signals when executed. Modules may also share data and information when executed. In the FIG. 2 embodiment, the memory 210 of end node 200 of the present invention includes a signaling/control module 212 and signaling/control data 214. The signaling/control module 212 includes a handoff control module 213 used to control handoff operations. The memory 210 also includes stored state information 215 which is state information corresponding to the end node 200 that was received from an access node with the intent that it be transmitted to a target access node as part of a handoff or synchronization operation. Thus the memory 210 temporarily stores the state information 215 optionally in encrypted form as part of a handoff. While shown as modules in memory, the handoff control module can, and in some embodiments is, implemented as a hardware module.

The signaling/control module 212 controls processing relating to receiving and sending signals, e.g., messages, for management of state information storage, retrieval, and processing. Signaling/control data 214 includes state information, e.g., parameters, status and/or other information relating to operation of the end node. In particular, the signaling/control data 214 may include configuration information 216, e.g., end node identification information, and operational information 218, e.g., information about current processing state, status of pending responses, etc. The module 212 may access and/or modify the data 214, e.g., update the configuration information 216 and/or the operational information 218.

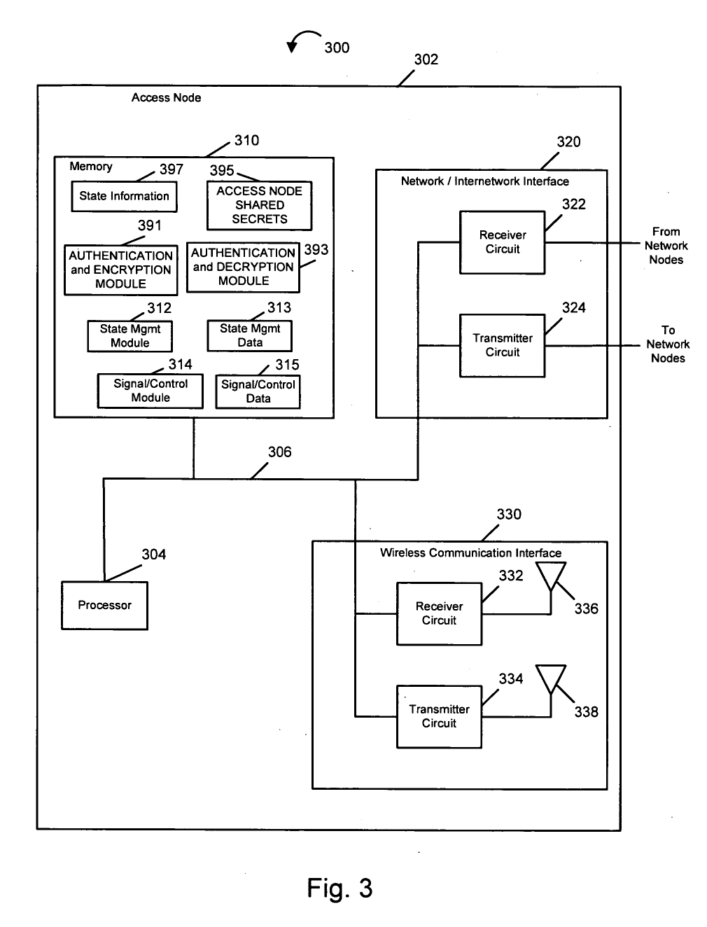

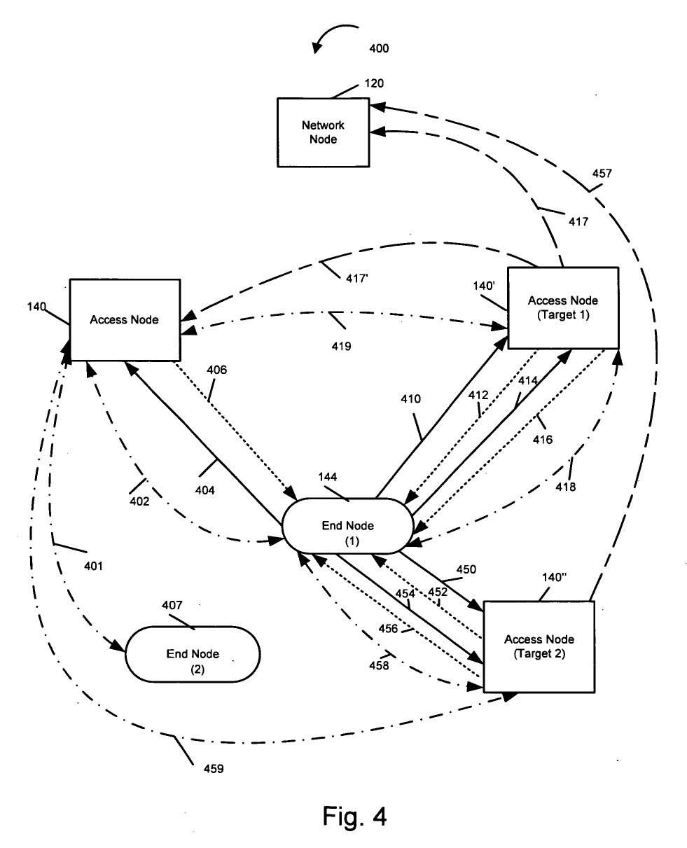

FIG. 3 provides a detailed illustration of an exemplary access node 300 implemented in accordance with the present invention. The access node 300 may serve as a current network attachment point or target in a handoff process. The exemplary access node 300, depicted in FIG. 3, is a detailed representation of an apparatus that may be used as any one of the access nodes 140, 140′, 140″ depicted in FIGS. 1 and 4. In the FIG. 3 embodiment, the access node 300 includes a processor 304, memory 310, a network/internetwork interface 320 and a wireless communication interface 330, coupled together by bus 306. Accordingly, via bus 306 the various components of the access node 300 can exchange information, signals and data. The components 304, 306, 310, 320, 330 of the access node 300 are located inside a housing 302.

The network/internetwork interface 320 provides a mechanism by which the internal components of the access node 300 can send and receive signals to/from external devices and network nodes. The network/internetwork interface 320 includes, a receiver circuit 322 and a transmitter circuit 324 used for coupling the node 300 to other network nodes, e.g., via copper wires or fiber optic lines. The wireless communication interface 330 also provides a mechanism by which the internal components of the access node 300 can send and receive signals to/from external devices and network nodes, e.g., end nodes. The wireless communication interface 330 includes, e.g., a receiver circuit 332 with a corresponding receiving antenna 336 and a transmitter circuit 334 with a corresponding transmitting antenna 338. The interface 330 is used for coupling the access node 300 to other network nodes, e.g., via wireless communication channels.

The processor 304 under control of various modules, e.g., routines, included in memory 310 controls operation of the access node 300 to perform various signaling and processing. The modules included in memory 310 is executed on startup or as called by other modules that may be present in memory 310. Modules may exchange data, information, and signals when executed. Modules may also share data and information when executed. In the FIG. 3 embodiment, the memory 310 of the access node 300 of the present invention includes a State Management module 312 and a Signaling/Control module 314. Corresponding to each of these modules, memory 310 also includes State Management data 313, the Signal/Control Module 314 and the Signaling/Control data 315.

The State Management Module 312 controls the processing of received signals from end nodes or other network nodes regarding state storage and retrieval, e.g., signals which may be part of a handoff operation and/or the process of supporting normally communications sessions and operating as a network attachment point. The State Management Data 313 includes, e.g., end-node related information such as the state or part of the state, or the location of the current end node state if stored in some other network node. The State Management module 312 may access and/or modify the State Management data 313.

The Signaling/Control module 314 controls the processing of signals to/from end nodes over the wireless communication interface 330, and to/from other network nodes over the network/internetwork interface 320, as necessary for other operations such as basic wireless function, network management, etc. The Signaling/Control data 315 includes, e.g., end-node related data regarding wireless channel assignment for basic operation, and other network-related data such as the address of support/management servers, configuration information for basic network communications. The Signaling/Control module 314 may access and/or modify the Signaling/Control data 315.

End node state information transferred between access nodes via an end node in accordance with the present invention is signed and optionally encrypted prior to transmission to an end node and authenticated and decrypted upon receipt from an end node. The memory 310 includes an authentication and encryption module 391 for performing the signing and encryption function and an authentication and decryption module 393 for performing the authentication and decryption function. In some embodiments authentication is used without encryption while in other embodiments encryption is used without authentication. Accordingly, modules 391, 393 are implemented to perform functions used in a given system and features which are not used or required in a particular embodiment may be omitted from the modules 391, 393. As defined in this invention, the signing function may include an integrity protection function which prevents third parties from modifying any part of a message that has been signed and integrity protected. These modules 391 and 393 may, and sometimes are, implemented as hardware modules as opposed to begin implemented as software modules. To support signing/authentication as well as encryption/decryption functions, the access node includes shared secrets 395 which are available to other access nodes and can be used for signing/authenticating and encrypting/decrypting state information transferred between access nodes. These shared secrets may be supplied by the AAA server 104 or input by a system administrator depending on the particular embodiment. The shared secret 395 provides a security association between access nodes in the system which also have access to the shared secret 395. In most but not necessarily all embodiments, the end nodes are denied access to a shared secret which would allow decryption and/or modification of the state information which is to be transferred. In this way, access nodes can trust state information received from a mobile node since it is signed, integrity protected and optionally encrypted by another trusted node (e.g., an access node).

State information 397 relating to, e.g., used to support, communication with an end node which operates as part of the system and uses the access node 302 as a point of network attachment is stored in memory, one set of state information being stored per end node. In one embodiment of this invention transferred state information will typically include static, long lived and short lived components. However, in other embodiments, the state transferred through the mobile may be a subset of these different types of state. Static components may include parameters that do not change over long periods of time and multiple communication sessions. Examples of static state are end node profile information such as general quality of service parameters (e.g.: peak rates allowed) and generic authorization state (e.g.: type of data calls allowed). Examples of long lived state are parameters that do not change during the duration of a communication session (e.g.: a dynamically assigned Internet address or some long lived security information). Examples of short lived state are parameters that are very dynamic in nature and change multiple times during a communications session (e.g.: dynamic quality of service state, multicast group membership, etc.)

In one embodiment of this invention state information (static, short and long lived) is moved together according to methods described in the present invention through the mobile node involved in a handoff from one access node to another access node, e.g., as a set of state information.

FIG. 4 illustrates the handoff method of the present invention. The arrows of FIG. 4 represent signals that are generated and transmitted in accordance with the invention. The transmission of signals correspond to various steps of the method performed in accordance with the invention.

In the FIG. 4 example, there is an ongoing communications session, e.g., voice call, between end node 1 144 and end node 2 407. Each of the nodes initially communicating through at least the first access node 140, the communication path optionally including other core network nodes, for example network node 120. Thus, at the start of the example shown in FIG. 4, the first access node 140 serves as the network attachment point for both end node 1 and end node 2. The access node 140 stores state information including a session identifier relating to the ongoing communications session, security information used in communicating with each of the mobile nodes, mobile node identification, mobile node profile information, including service authorization information etc. for each of the first and second mobile nodes 144, 407. As the mobile node moves away from the first access node, as represented by arrow 411, towards second and third access nodes 140′, 140″, the mobile node decides to initiate a handoff from the current network attachment point, i.e., the first access node 140 to another access node, e.g., the second access node 140′. The handoff decision may be made in the mobile node based on signal strength measurements made by the mobile node of signals received from each of the access nodes 140, 140′ and 140″. In an alternative embodiment of this invention the handoff decision is made by the network, e.g., by access node 140 which monitors various parameters e.g., signal strength between it self and end node 144. In this embodiment of the invention access node 140 also monitors communication parameters between end node 144 and access nodes 140′ and 140″, via reports from end node 144. In another embodiment of this invention said reports are received from access nodes 140′ and 140″. In this exemplary embodiment of the invention the end node initiated handoff case is illustrated further below.

Having made the decision to initiate a handoff, the first end node 144 sends a handoff initiation message 404, which may be in the form of a state transfer request message, to the first access node 140 which is serving as the end nodes current network attachment point. The first access node responds to the handoff initiation message by signing and optionally encrypting the current state available in the first access node 140 corresponding to the first end node 144 and transmitting the state information to the end node 144. Signal 406 represents the transmission of the state information to the first end node 144. In an alternative embodiment of this invention the signal 406 is sent to end node 144 independently from signal 404. In this embodiment of the invention the state held by access node 140 is updated as communications between end node 144 and nodes, e.g., end node 407 progress and change the parameters held by access node 140 to support said communications. The state is then sent to end 144 in message 406 as it gets updated so it is available to the end node 144 at the time it is needed. In the embodiment of this invention where the handoff is network controlled, signal 406, apart from the signal, it also includes an identifier identifying the access node, the end node 144 needs to handoff to (e.g., access node 140′ or 140″). The signing and optional encryption performed by the first access node 140 is done using security information, e.g., a shared secret, which is available to other access nodes due to a security association between access nodes. The shared secret may be programmed into the access nodes, e.g., by a system administrator, or supplied by a security server in the network depending on the particular embodiment.

Normally, the end node 144 does not have access to the shared secret needed to decrypt and re-sign the state information so that the first end node 144 serves as a conduit of the encrypted state information but will, in most embodiments, not alter the encrypted information. The mobile node may send additional information to a target base station along with the state information as part of a handoff but normally does not alter the state information. However, in other embodiments, the mobile node is allowed to modify the state information with the information prior to transmission to the target base station.

In the FIG. 4 example, the end node 144 selected the second access node 140′ as the first target access node. The first end node will try and complete the handoff to the first target access node 140′ but will select a different target 140″ if the handoff can not be completed to the first target access node 140′.

After selection of the first target access node 140′, the end node sends a handoff request signal 410 to the first target access node 140′ indicating that the first end node 144 is seeking to complete a handoff to the access node 140′. The first target access node 140′ response with a signal 412 indicating that it will either accept the first end node 144 into the cell or declines the handoff.

If the response signal 412 indicates that the first target access node will allow the handoff of the first end node 144 to be completed to the first target access node 140′, the first end node 144 sends, in signal 414, the state information corresponding to the first end node 144 to the first access node 140′. The first target access node 140′ decrypts the state information and uses the information to establish a communication link with the end node 144 thereby making the first access node 140′ the new network attachment point for the end node 144. The first target access node 140′, after successful decryption of the state information transmits a routing update signal 417 to one or more network nodes 120 and, optionally, a signal 417′ to the old network attachment point 140 indicating that packets directed to the first end node 144 should be routed to said first target access node 140′. The signal 417′ operates as a handoff completion message indicating to the old access node that the handoff has been successful. The first access node also sends a signal 416 indicating a successful handoff to the first end node 144.

In an alternative embodiment of this invention the state information sent to access node 140′ is included in the handoff request signal 410. The first target access node 140′ decrypts the state information and uses the information to establish a communication link with the end node 144 thereby making the first access node 140′ the new network attachment point for the end node 144. The first target access node 140′, after successful decryption of the state information transmits a routing update signal 417 to one or more network nodes 120 and, optionally, a signal 417′ to the old network attachment point 140 indicating that packets directed to the first end node 144 should be routed to said first target access node 140′. The signal 417′ operates as a handoff completion message indicating to the old access node that the handoff has been successful. The first access node also sends a signal 416 indicating a successful handoff to the first end node 144. In this embodiment of the invention message 412 and 414 are not required.

Upon receiving packets with an address corresponding to the first end node 144, after the handoff has been completed, the first target access node 140′ will communicate them over the air link to the first end node 144. With the handoff having been completed, the existing communications session between the first and second end nodes 144, 407, identified by the session identifier included in the state information supplied to the first target access node 140′, is permitted to continue with the first and second access nodes 140, 140′ serving to couple the first and second end nodes 144, 407 together. The exchange of signals after the handoff which includes the communication of IP packets including, for example, voice data, relating to communications session is represented in FIG. 4 by arrows 401, 418, 419.

The above discussion assumed that the first target access node 140′ accepted the handoff of the first end node 144. If the response signal 412 indicated that the first target access node would not allow the handoff of the first end node 144 to be completed to the first target access node 140′, the first end node 144 selects a second target access node 140″ to complete the handoff to. The handoff then proceeds in the same manner as discussed above but with the second target access node 140″ rather than the first access node 140′. Such a case is shown by exemplary signals 450, 452, 454, 456, 458.

In the embodiment of the invention where the messages 412 and 414 are not required and the state in included in message 410, access node 140′ basis its decision whether to access end node 144 or not on multiple parameters included but not limited to the loading on access node 140′ and the credentials of end node 144 that are included in the state included in message 410. If the response signal 416 indicated that the first target access node would not allow the handoff of the first end node 144 to be completed to the first target access node 140′, the first end node 144 selects a second target access node 140″ to complete the handoff to. The handoff then proceeds in the same manner as discussed above but with the second target access node 140″ rather than the first access node 140′. Such a case is shown by exemplary signals 450, 452, 454, 456, 458.

After selection of the second target access node 140″, the end node 144 sends a handoff request signal 450 to the second target access node 140″ indicating that the first end node 144 is seeking to complete a handoff to the access node 140″. The second target access node 140″ responds with a signal 452 indicating that it will either accept the first end node 144 into the cell or declines the handoff.

If the response signal 452 indicates that the second target access node 140″ will allow the handoff of the first end node 144 to be completed to the second target access node 140″, the first end node 144 sends, in signal 454, the state information corresponding to the first end node 144 to the second target access node 140″. In an alternative embodiment of this invention the state information is included in handoff request signal 450. The second target access node 140″ decrypts the state information and uses the information to establish a communication link with the end node 144 thereby making the second access node 140″ the new network attachment point for the end node 144. The second target access node 140″, after successful decryption of the state information transmits a routing update signal 457 to one or more network nodes 120 and, optionally, another signal (not shown) to the old network attachment point 140 indicating that packets directed to the first end node 144 should be routed to said second target access node 140″. The signal to the first access node 140 operates as a handoff completion message indicating to the old access node that the handoff has been successful. The second access node also sends a signal 456 indicating a successful handoff to the first end node 144.

Upon receiving packets with an address corresponding to the first end node 144, after the handoff has been completed, the second target access node 140′ will communicate them over the air link to the first end node 144. With the handoff having been completed, the existing communications session between the first and second end nodes 144, 407, identified by the session identifier included in the state information supplied to the second target access node 140′, is permitted to continue with the first and third access nodes 140, 140″ serving to couple the first and second end nodes 144, 407 together. The exchange of signals after the handoff which includes the communication of IP packets including, for example, voice data, relating to communications session is represented in FIG. 4 by arrows 401, 458, 459.

In another embodiment of the invention the signaling illustrated in FIG. 4 is used to create additional links between end node 144 and access nodes 140′ and 140″. In this embodiment of the invention signals 417 and 457 as well as optional signals 417′ may be omitted so as not to change routing for end node 144. In the same embodiment of the invention messages 417, 457 and 417′ may be triggered by the end node 144 or they may be triggered by access nodes 140, 140′ and 140″ by additional signaling that is independent from the rest of the signals presented in FIG. 4 but are not shown in the figure.

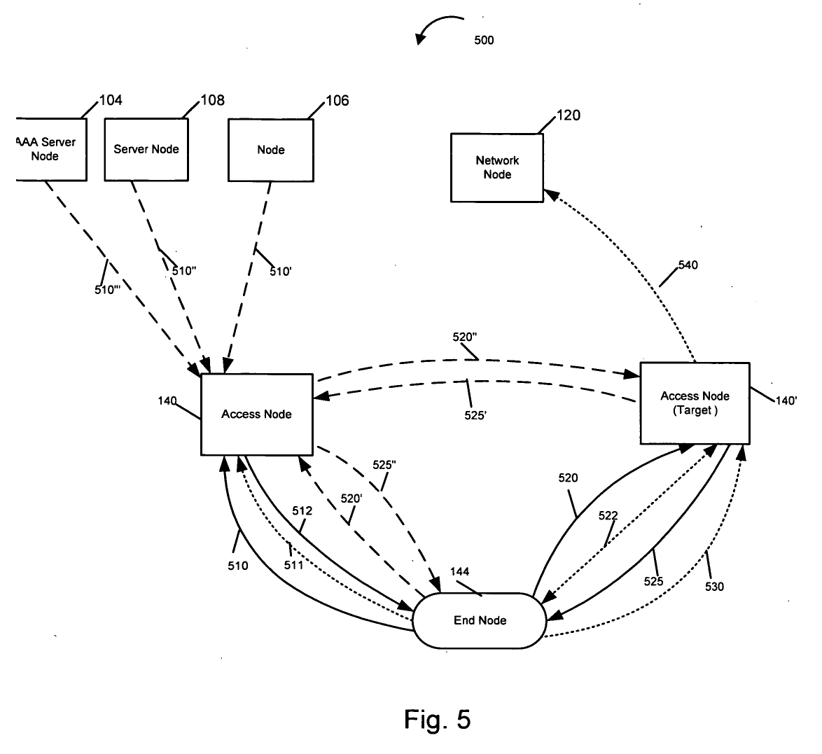

FIG. 5 illustrates an additional handoff method of the present invention. The arrows of FIG. 5 represent signals that are generated and transmitted in accordance with the invention. The transmission of signals corresponds to various steps of the method performed in accordance with the invention.

In the FIG. 5 example, there is an ongoing communications session, e.g., a voice call, between end node 144 and node 106. End node 144 initially communicates through at least the first access node 140, the communication path optionally includes other core network nodes, for example network node 120. Thus, at the start of the example shown in FIG. 5, the first access node 140 serves as the network attachment point for at least end node 144. The access node 140 stores state information including a session identifier relating to the ongoing communications session, security information used in communicating with each of the mobile nodes, mobile node identification, mobile node profile information, including service authorization information etc. for at least end node 144. The access node 140 normally stores such information for a plurality of end nodes which are actively communicating through the access node 140.

In FIG. 5, in accordance with the invention, state associated with end node 144 is maintained by access node 140, modified, and updated as part of the operation of communicating between end node 144 and other nodes e.g., node 106. In one embodiment of this invention state changes are caused by communications 510′″ between the AAA Server 104 and access node 140 e.g., during an authentication and authorization session for end node 144. State changes are also caused by communications 510″ between server node 108 and access node 140. State changes can also be caused by communications 510′ between a node 106 and end node 144 via access node 140 (e.g., a voice call). State changes can also be caused by communications 510 between end node 144 and access node 140 (e.g., a request for resources). State changes can also be caused by internal operations of access node 140. State changes can also be caused by, and/or be in response to, other communications signals. According to one embodiment of this invention access node 140 sends state updates to end node 144 as such updates take place e.g., with message 512 in response to messages 510, 510′, 510″, 510′″. In another embodiment of this invention end node 144 requests the updated state by sending message 511 and access node 140 sends the state to end node 144 in message 512. Alternatively, updated state is sent at specific times, e.g., at planned intervals which may result in periodic updates. One or more of these methods of determining when to send state to the end node 144 may be used.

In one embodiment of this invention, the state included in message 512 of FIG. 5 is opaque, e.g., not readable, to the terminal. The state may be opaque due to the use of encryption or coding which the mobile can not decrypt or decode. In one such embodiment of the invention when access node 140 sends message 512 including state associated with end node 144 it sends all the state available and end node 144 replaces the existing state with new state received in message 512. In an alternative embodiment of the invention the state is split in portions numbered with an index from 1 to N. Access node 140 sends a subset of the indexed opaque state objects to the end node 144. In this embodiment of the invention end node 144 does not normally replace the entire set of stored state with the received state included in message 512 but rather replaces the store state which corresponds to objects included in the received message 512. This normally results in a portion of the state being replaced but all the state could be updated as a result of message 512. The replacement is performed by searching is memory for each of the indexes included in message 512 which are used to identify sets of state and replacing the corresponding stored object in memory with the object in message 512. In this manner, the objects which represent opaque subsets of state can be replaced without having to replace the entire set of state which will normally include multiple objects.

In the FIG. 5 example, as the mobile node moves away from the first access node, towards second access nodes 140′ the end node 144 decides to initiate a handoff from the current network attachment point, i.e., the first access node 140 to another access node, e.g., the second access node 140′. The handoff decision may be made in the end node 144 based on signal strength measurements made by the end node of signals received from each of the access nodes 140 and 140′. In an alternative embodiment of this invention the handoff decision is made by a network, e.g., by access node 140 or network based control node which monitors various parameters e.g., signal strength between it self and end node 144. In such an embodiment of the invention access node 140 also monitors communication parameters between end node 144 and access 140′, via reports from end node 144. In another embodiment of this invention said reports are received from access nodes 140′.

An exemplary embodiment of the invention, where the end node initiates handoff, will now be discussed further with respect to FIG. 5 and the signals included therein.

End node 144 sends handoff request message 520 to the target access node 140′. Message 520 includes the latest version of the state received from access node 140 in message 512. In an alternative embodiment of this invention message 520 is sent as message 520′ via access node 140 which just replays the message 520″ to the target access node 140′. Access node 140′ uses, in the exemplary embodiment, at least part of the state include in message 520/520″ to establish a communication path between itself and end node 144 that can support at least some of end node's 144 communications via access node 140 (e.g., a voice call between end node 144 and node 106). Optionally, communications represented by double arrow 522 are performed between end node 144 and access node 140′. Such communication 522 may include, e.g., communication to implement mutual authentication procedures. Access node 140′ replies to the end node 144 by transmitting message 525 to end node 144 indicating the outcome of the handoff process. Message may indicate success and/or failure of the attempted handoff. In another embodiment of the invention, the reply message 525 is sent via access node 140 in the form of message 525′, which is relayed by access node 140 to end node 144 as message 525″.

Assuming that the handoff to the access node 140′ is successful, seems likely to be successful, or communication with access node 140 is not likely to remain possible, end node 144 sends message 530 requesting a routing change so that all of its communications currently flowing via access node 140 are now flowing via access node 140′. Access node sends routing change message 540 to point routing of end node 144 communications to it. In one embodiment of the invention routing change message 530 is sent immediately after handoff reply message 525 is received by end node 144. In another embodiment of the invention the process causing message 530 to be sent is independent of message 525 e.g., it is driven by downlink air interface quality measurements.

In various embodiments nodes described herein are implemented using one or more modules to perform the steps corresponding to one or more methods of the present invention, for example, signal processing, message generation and/or transmission steps. Thus, in some embodiments various features of the present invention are implemented using modules. Such modules may be implemented using software, hardware or a combination of software and hardware. Many of the above described methods or method steps can be implemented using machine executable instructions, such as software, included in a machine readable medium such as a memory device, e.g., RAM, floppy disk, etc. to control a machine, e.g., general purpose computer with or without additional hardware, to implement all or portions of the above described methods, e.g., in one or more nodes. Accordingly, among other things, the present invention is directed to a machine-readable medium including machine executable instructions for causing a machine, e.g., processor and associated hardware, to perform one or more of the steps of the above-described method(s).

Numerous additional variations on the methods and apparatus of the present invention described above will be apparent to those skilled in the art in view of the above description of the invention. Such variations are to be considered within the scope of the invention. The methods and apparatus of the present invention may be, and in various embodiments are, used with CDMA, orthogonal frequency division multiplexing (OFDM), or various other types of communications techniques which may be used to provide wireless communications links between access nodes and mobile nodes. In some embodiments the access nodes are implemented as base stations which establish communications links with mobile nodes using OFDM and/or CDMA. In various embodiments the mobile nodes are implemented as notebook computers, personal data assistants (PDAs), or other portable devices including receiver/transmitter circuits and logic and/or routines, for implementing the methods of the present invention.

What is claimed is:

1. A communications method for use in a communications system including a first access node, a second access node and an end node, the method comprising:
operating the end node to receive from the first access node state information corresponding to said end node; and
operating the end node to communicate state information to the second access node.

2. The method of claim 1, wherein said received state information is encrypted state information and wherein said communicating state information to the second access node includes transmitting the encrypted state information to said second access node.

3. The method of claim 2, further comprising:
sending a handoff signal to said second access node, prior to sending said encrypted state information to said second access node, to signal that said end node is initiating a handoff to said second access node.

4. The method of claim 3, further comprising:
operating the second access node to receive said encrypted state information;
operating the second access node to decrypt said encrypted state information; and
operating the second access node to use at least some of said decrypted state information to enable a communications session between said end node and another node.

5. The method of claim 4, wherein said decrypted state information includes at least some information about a communications session which was being conducted between said end node and said another node through said first access node, said communications session being continued through said second access node after said handoff.

6. The method of claim 5, further comprising:
operating the first access node to transmit said state information to said end node includes transmitting said first information from a wireless communications link established between said first access node and said wireless terminal.

7. The method of claim 6, wherein said first and second access nodes have a security association with one another and share a common shared secret used for encrypting and decrypting state information communicated through a end node.

8. The method of claim 7, further comprising the step of operating the second access node to transmit a routing update signal to another node after said state information is decrypted.

9. The method of claim 1, wherein operating the end node to receive from the first access node state information corresponding to said end node includes receiving said state information over a wireless communications link.

10. The method of claim 1, wherein said end node maintains communications links with the first access node and the second access node and wherein said step of operating the end node to communicate said state information to the second access node is performed as part of a state synchronization operation between the first access node and the second access node performed to synchronize state information that enables said first and second access nodes to support communications sessions between said end node and another node.

11. The method of claim 1, wherein said step of operating the end node to communicate state information to the second access node is performed as part of a handoff operation to the second access node.

12. The method of claim 11, wherein said state information includes at least one of:
an access key to be used in obtaining at least one of secure access and authenticated access to said second access node;
a master session key to be used in obtaining at least one of secure access and authenticated access to said second access node;
service authorization information indicating at least one service the end node is authorized to be provided with;
a communications session identifier identifying an ongoing communications session, resource allocation information indicating resources allocated to an ongoing communications session;
air link resource information; communications group membership information; and
an IP address assigned to said end node and an address lifetime corresponding to said IP address.

13. The method of claim 11, further comprising:
storing said state information received form the first access node prior to operating the end node to communicate at least some received state information;
receiving additional state information;
replacing at least some of said stored state information with at least some of said additional state information; and
wherein operating the end node to communicate state information to the second access node includes transmitting at least some of the additional state information which replaced at least some of the stored state information.

14. The method of claim 13, wherein replacing at least some of said stored state information includes replacing a full set of stored state information previously received from the first access node; and
wherein said received additional state information is also from the first access node.

15. The method of claim 13, further comprising:
operating the wireless terminal to continue a communications session through said second access node, said communications session being identified by a session identifier included in the state information transmitted from said wireless terminal to said second access node.

16. A wireless terminal for use in a communications system including a first access node and a second access node, the end node comprising:
a handoff control module for controlling the end node to transmit and receive handoff related signals as part of a handoff operation;
a transmitter module coupled to said handoff control module for transmitting handoff related control signals under control of said handoff control module;
a receiver module coupled to said handoff control module for receiving handoff related signals; and
wherein said handoff control module is configured to transmit a handoff signal to said first access node when said end node is performing a handoff operation from said end node and to transmit encrypted state information received from said first access node to the second access node when said handoff operation is a handoff from said first access node to said second access node, said encrypted state information corresponding to said end node and including state information previously maintained at said first access node.

17. The wireless terminal of claim 16, wherein said transmitter module is a wireless transmitter module for transmitting signals over air.

18. The wireless terminal of claim 17, wherein said wireless transmitter module is an OFDM transmitter.

19. The wireless terminal of claim 17, further comprising:
a communications module for continuing a communications session with another node that was being conducted through said first access node through said second access node after a handoff to said second access node.

20. The wireless terminal of claim 19, wherein at least some of the encrypted state information includes a communications session identifier corresponding to said communications session with said another node.

21. A communications method for use in a communications system including a first access node, a second access node and a end node, the method comprising:
operating the end node to receive from the first access node state information corresponding to said end node; and
operating the end node to communicate said state information to the second access node.

22. The method of claim 21, wherein said communicating said state information to the second access node includes transmitting the encrypted state information to said second access node.

23. The method of claim 22, wherein said state information is transmitted in a connection request message requesting the establishment of a link; and
operating said end node to receive a connection establishment response message indicating the establishment of said link.

24. The method of claim 23, wherein said state information is signed state information.

25. The method of claim 24, further comprising:
operating the second access node to receive said state information;
operating the second access node to authenticate the signature of said signed state information;
operating the second access node to use at least some of said authenticated state information to verify the identity of end node sending said signed state information; and
operating second access node to grant the establishment of a connection between said second access node and said end node if said end node identity is valid.

26. The method of claim 25, wherein said authenticated state information includes at least some information about a communications session which was being conducted between said end node and said another node through said first access node, said communications session being continued through said second access node after said handoff.

27. The method of claim 26, wherein said first and second access nodes have a security association with one another and share a common shared secret used for signing and authenticating signed state information communicated through a end node.

28. The method of claim 27, wherein said state information is also encrypted state information.

29. The method of claim 28, wherein said first and second access nodes have a security association with one another and share a common shared secret used for encrypting and decrypting state information communicated through a end node.

30. The method of claim 29, further comprising the step of operating the second access node to transmit a routing update signal to another node after said state information is decrypted.

31. A method of operating a first access node in a communications system including at least said first access node, a second access node and an end node, the method comprising:
using a set of state information corresponding to the end node to support a communications session with said end node; and
transmitting at least some of said state information to said end node.

32. The method of claim 31, wherein said state information includes information which can be used to support a handoff operation.

33. The method of claim 31, further comprising:
including authentication information with said state information which is transmitted to said end node.

34. The method of claim 34, wherein said authentication information is a function of the state information being communicated and can be used to detect modification of the transmitted state.

35. The method of claim 34, wherein said authentication information is a function of the state information being communicated and a function of a key which is known to said first and second access nodes.

36. The method of claim 31, further comprising:
prior to transmitting said state, receiving a state request signal from said end node.

37. The method of claim 31, wherein said state information authentication information is a function of the state information being communicated and can be used to detect modification of the transmitted state.

38. The method of claim 36, wherein the state request signal is a handoff signal.

39. The method of claim 33, further comprising:
detecting a change in state corresponding to said end node; and
wherein said transmitting is in response to detecting said change.

40. The method of claim 37, wherein the transmitted state includes at least some of said changed state.
